(19) United States
(12) Patent Application Publication
(10) Pub. No.: US 2010/0156271 A1
(43) Pub. Date: Jun. 24, 2010

(54) FLUORESCENT SCREEN AND IMAGE DISPLAY APPARATUS

(75) Inventor: Ginjiro Toyoguchi, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/640,123

(22) Filed: Dec. 17, 2009

(30) Foreign Application Priority Data
Dec. 19, 2008 (JP) 2008-324471

(51) Int. Cl. H01J 1/62; H01J 21/10; H01J 9/24

(52) U.S. Cl. 313/494; 313/306; 445/23

(57) ABSTRACT

An apparatus includes light emitting members; anode electrodes disposed on the light emitting members in an overlapping manner; a partition member disposed between adjacent light emitting members; a resistance member disposed on the partition member, the resistance member connecting adjacent anode electrodes to each other; and a feeding electrode connecting the resistance member to a power supply, wherein the feeding electrode is disposed on a base adjacent to the partition member, and the feeding electrode is connected, on the base, to the resistance member and to a power supply.

### BACKGROUND OF THE INVENTION

1. Field of the Invention

The present invention relates to a fluorescent screen used for an image display apparatus.

2. Description of the Related Art

Display apparatuses of a certain type display images by irradiating light emitting members with electrons emitted from electron emitting devices. In order to improve the brightness of such display apparatuses, the electrons should be sufficiently accelerated before the light emitting members are irradiated with the electrons. To do so, a high voltage has to be applied to anodes. However, since display apparatuses have become thinner in recent years, discharge may occur between the electron emitting devices on a rear plate and anode electrodes on a face plate (fluorescent substrate).

In an image display apparatus that displays images by irradiating light emitting members with electrons, a phenomenon is observed in that, when electrons emitted from electron-emitting devices enter the light emitting members, some of the electrons are reflected. The electrons that have been reflected (hereinafter referred to as reflected electrons) are accelerated by a voltage between an anode and the electron-emitting devices and reenter the light emitting members, thereby causing a phenomenon called halation.

Halation refers to degradation of a displayed image due to a decrease in contrast or color purity, which occurs when electrons reflected by the light emitting members enter the light emitting members in adjacent regions and make the light emitting members in a non-selected area emit light. To date, measures against halation have been studied.

Regarding measures against discharge and halation, Japanese Patent Laid-Open No. 2007-005232 discloses a face plate including a plurality of anode electrodes and a resistance member. In order to suppress damage due to discharge, the anode electrodes are arranged in a matrix pattern so as to cover phosphors, and the resistance member connects adjacent anode electrodes to one another. In order to suppress halation, the face plate includes a partition wall disposed between adjacent phosphors so as to protrude from a surface of the face plate toward a rear plate, and the resistance members are disposed on an upper surface of the partition wall. In order to suppress damage that may be caused by discharge between a power feed section and the rear plate, the face plate includes depressions and protrusions on a peripheral part of a surface thereof and the power feed section is disposed on the depressions and protrusions, the power feed section connecting the anode electrodes to a power supply.

However, with the structure disclosed in Japanese Patent Laid-Open No. 2007-005232, since the power feed section is disposed on the depressions and protrusions, a breakage of the power feed section may occur at a stepped portion between a depression and a protrusion (hereinafter referred to as a “step breakage”). In this case, the resistance of the power feed section may increase or the power feed section may become completely disconnected. Hence the structure may have an issue in that power may not be stably fed from the power supply to the anode electrodes.

### SUMMARY OF THE INVENTION

According to an embodiment of the present invention, an apparatus includes a substrate; light emitting members disposed on the substrate; anode electrodes disposed on the light emitting members in an overlapping manner; a partition member disposed between adjacent light emitting members, the partition member protruding from a surface of the substrate; a resistance member disposed on the partition member, the resistance member connecting adjacent anode electrodes to each other; and a feeding electrode connecting the resistance member to a power supply, wherein the feeding electrode is disposed on one of the partition member and a base adjacent to the partition member, the feeding electrode is in contact, on one of the partition member and the base, with the resistance member, and the feeding electrode includes a connection portion at which the feeding electrode is connected to the power supply, the connection portion being disposed on one of the partition member and the base.

Further features of the present invention will become apparent from the following description of exemplary embodiments with reference to the attached drawings.

### BRIEF DESCRIPTION OF THE DRAWINGS

FIG. 1 is a perspective cutaway view illustrating an overall structure of an image display apparatus according to an embodiment of the present invention.

FIG. 2A is a plan view of a face plate according to an embodiment of the present invention, and FIG. 2B is a plan view of a rear plate according to an embodiment of the present invention.

FIG. 3 is a partial sectional view of an image display apparatus using the face plate illustrated in FIG. 2.

FIG. 4 is a partial sectional view of an image display apparatus using the face plate illustrated in FIG. 2.

FIG. 5 is a partial sectional view of an image display apparatus using the face plate illustrated in FIG. 2.

FIG. 6 is a plan view of another face plate according to an embodiment of the present invention.

FIG. 7 is a partial sectional view of an image display apparatus using the face plate illustrated in FIG. 6.

FIG. 8 is a plan view of another face plate according to an embodiment of the present invention.

FIG. 9 is a partial sectional view of an image display apparatus using the face plate illustrated in FIG. 8.

FIG. 10 is a partial sectional view of an image display apparatus using the face plate illustrated in FIG. 8.

FIG. 11 is a plan view of a face plate including partition members having grid-like portions.

### DESCRIPTION OF THE EMBODIMENTS

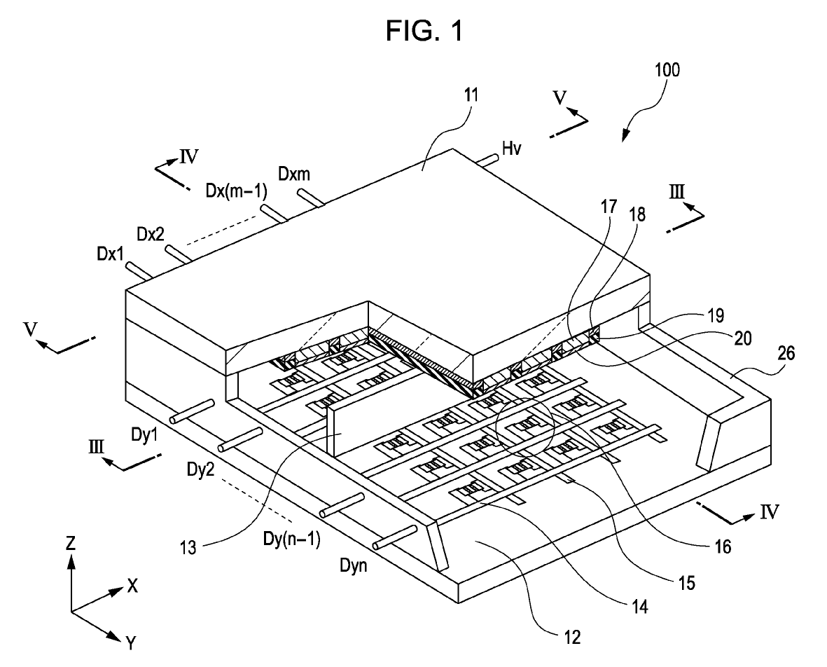

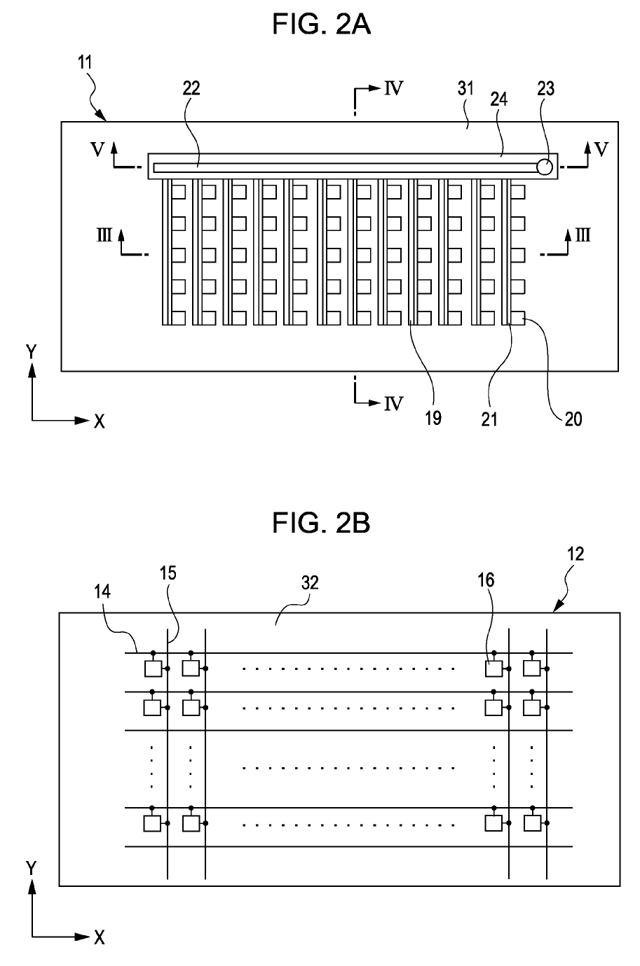

Hereinafter, embodiments of the present invention are described in detail with reference to the drawings. FIG. 1 is a perspective cutaway view illustrating an overall structure of an image display apparatus 100 according to an embodiment of the present invention. FIG. 2A is a plan view of a face plate 11 of the image display apparatus 100 serving as a fluorescent screen viewed from a rear plate 12.

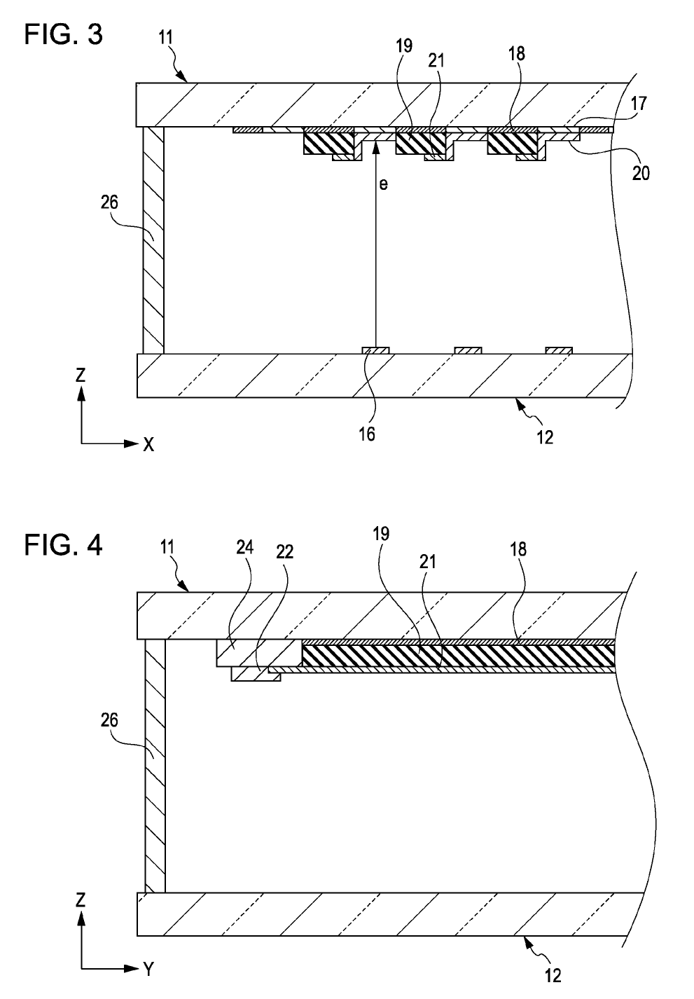

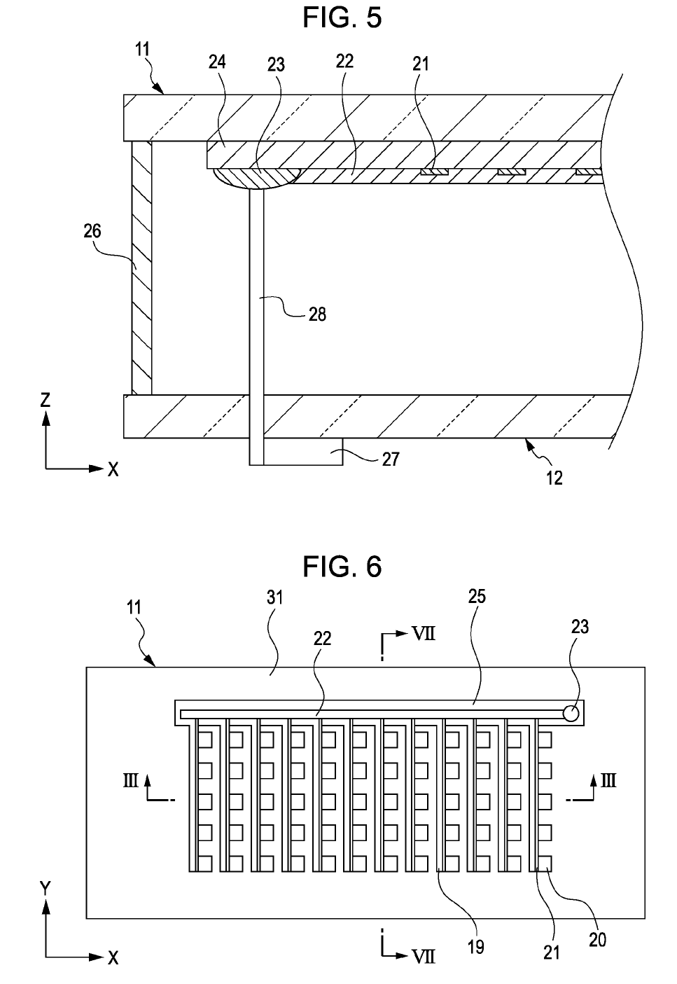

FIG. 2B is a plan view of the rear plate 12 viewed from the face plate 11 serving as a fluorescent screen. FIG. 3 is a sectional view taken along line III-III in FIG. 1. FIG. 4 is a sectional view taken along line IV-IV in FIG. 1. FIG. 5 a sectional view taken along line V-V in FIG. 1. In order to clearly indicate positional relationships among the face plate serving as a fluorescent screen and lines III-III, IV-IV, and V-V in FIG. 1, the lines III-III, IV-IV, V-V are also drawn in FIG. 2A. Hereinafter, the face plate serving as a fluorescent screen is simply referred to as the face plate. The rear plate 12 includes a back substrate 32 and electron-emitting devices 16 disposed on the back substrate 32. As illustrated in FIG. 2B, in the present embodiment, the electron emitting devices 16 are connected to one another in a matrix pattern by scanning wiring lines 14 and information wiring lines 15.

The face plate 11 includes a front substrate 31, light emitting members 17 disposed on the front substrate 31, and anode electrodes 20 disposed on the light emitting members 17 in an overlapping manner. The light emitting members 17 emit light when being irradiated with electrons emitted from the electron emitting devices 16. The face plate 11 includes partition members (ribs) 19 disposed between adjacent light emitting members 17. The partition members 19 protrude so as to be closer to the rear plate 12 than a surface of the front substrate 31. The face plate 11 includes strip-shaped resistance members 21 disposed on portions of the partition members 19 facing the rear plate 12. The strip-shaped resistance members 21 connect the anode electrodes 20 that are adjacent to one another in the Y direction. A power supply 27 for supplying a high voltage to the strip-shaped resistance members 21 is disposed outside the image display apparatus 100. The face plate 11 includes a feeding electrode 22 through which the strip-shaped resistance members 21 are connected to the power supply 27 so as to prevent a voltage drop that may occur in accordance with the distance from the power supply 27.

By disposing the partition members 19 between adjacent light emitting members 17 and disposing the strip-shaped resistance members 21 on the portions of the partition members 19 facing the rear plate 12, the strip-shaped resistance members 21 do not obstruct light emitted from the light emitting members 17. Thus, light is effectively used and the brightness of the image display apparatus is improved. Since the strip-shaped resistance members 21 connected to the anode electrodes 20 are disposed on the portions of the partition members 19 facing the rear plate 12, the anode electrodes 20 adjacent to one another in the X direction are securely insulated from one another. As a result, the breakdown voltage between the anode electrodes 20 that are adjacent to one another in the X direction is increased. Thus, various benefits may be obtained by disposing the resistance members 21, which connect adjacent anode electrodes 20, on the partition members 19. However, since the resistance members 21 are disposed on the partition members 19 and the feeding electrode 22, which connects the resistance members 21 to the power supply 27, is disposed on the front substrate 31, a step breakage (disconnection) may occur at a connection portion between the resistance members 21 and the feeding electrode 22. As a result, the power may not be stably supplied to the anode electrodes 20 connected to the resistance members 21.

As illustrated in FIGS. 2, 4, and 5, in the present embodiment, the resistance members 21, which are disposed on the partition members 19, and the feeding electrode 22, which is provided so as to prevent a voltage drop between the power supply 27 and the resistance members 21, are disposed on a base 24 adjacent to the partition members 19. The feeding electrode 22 is in contact with the resistance members 21 on the base 24, and the feeding electrode 22 is in contact with a terminal to the power supply 27 on the base 24. Thus, a stepped portion, which may cause a step breakage, does not exist on an electrical path from the resistance members 21 to the power supply 27, so that a voltage can be stably supplied to the anode electrodes 20 connected to the resistance members 21. The feeding electrode 22 is in contact with the power supply 27 at a connection portion 23 illustrated in FIG. 5. A high-voltage pin 28 is a rod-shaped power supply terminal through which an output voltage of the power supply 27 disposed outside the image display apparatus 100 is extended to the face plate 11.

Materials of components of the present embodiment are described below in detail.

As the front substrate 31, glass or other material that transmits visible light can be used. In the present embodiment, high-strain-point glass such as PD200 can be used.

As the anode electrodes 20, metal backs for CRT and the like, which are made of aluminum or other material, can be used. Patterning of the anode electrodes 20 can be performed by vapor deposition using masks, by etching, or by other methods. Since electrons pass through the anode electrodes 20 to reach the light emitting members 17, the thickness of the anode electrodes 20 is appropriately set by taking into account the energy loss of electrons, a predetermined acceleration voltage (anode voltage), and reflection efficiency of light. If a voltage in the range from 5 kV to 15 kV is to be applied to the anode electrodes 20, the thickness of the anode electrodes 20 is set in the range from 50 nm to 300 nm. If transparent electrodes made of ITO or the like are used as the anode electrodes 20, it is not necessary that the anode electrodes 20 be disposed so as to cover the light emitting members 17 in an overlapping manner as illustrated in FIGS. 2A and 3. In this case, the anode electrodes 20 may be disposed between the face plate 11 and the light emitting members 17.

As the light emitting members 17, a crystal phosphor that emits light when being excited by an electron beam can be used. Regarding the phosphor material, phosphors used for existing devices such as CRT, which are described, for example, in “Phosphor Handbook” (edited by the Phosphor Research Society and published by Ohmsha Ltd.) can be used. The thickness of the phosphor is appropriately set in accordance with an acceleration voltage, the particle diameter of the phosphor, and the packing density of the phosphor. If an acceleration voltage in the range from 5 kV to 15 kV is to be applied to the anode electrodes 20, the thickness of the phosphor is set in the range from 4.5 μm to 30 μm, which is 1.5 to 3 times larger than the average particle diameter of a general phosphor (which is in the range from 3 to 10 μm). The thickness of the phosphor can be in the range from 5 to 15 μm.

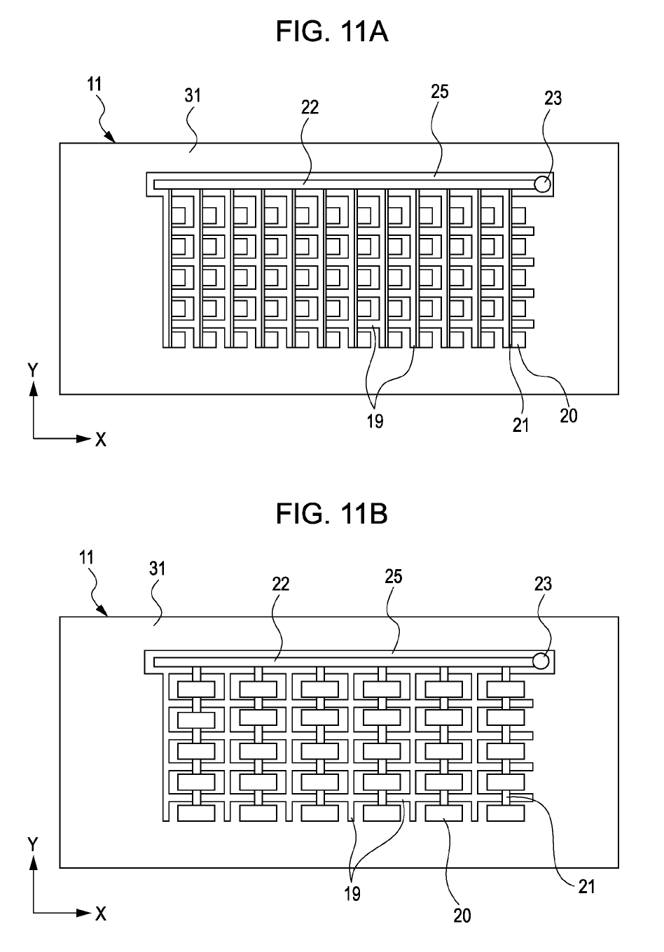

The partition members (ribs) 19 can be made of an inorganic mixture having a high resistance close to insulation, such as a glass material including a metal oxide. Examples of the metal oxide include lead oxide, zinc oxide, bismuth oxide, boron oxide, aluminum oxide, silicon oxide, and titanium oxide. Patterning of the partition members 19 can be performed by sandblasting, application of a photosensitive paste, etching, or the like. The height of the partition members 19 can be appropriately set in accordance with the specifications of the image display apparatus. The height of the partition members 19 can be set in the range from 0.5 to 10 times larger than the width of the light emitting members 17 (the length in the X or Y direction). For example, if the width of one of the light emitting members 17 is 50 μm, the height of the partition members 19 can be in the range from 25 μm to 500 μm. This setting serves to reduce the occurrence of so-called halation, which is a phenomenon that some of the light emitting members 17 emit light by being irradiated with electrons reflected by other light emitting members 17. The partition members 19 are not limited to the members constituted by strip shaped portions separated from one another as illustrated in FIG. 2A. The partition members 19 may be constituted by grid shape member, as illustrated in FIGS. 11A and 11B. FIGS. 11A and 11B, which respectively correspond to FIG. 2A and FIG. 8, illustrate face plates including the partition members 19 constituted by grid shape member. If the partition members 19 are constituted by grid shape member, a benefit is obtained in that halation described above can be reduced in two directions (in the X and Y directions). Thus, the present invention is applicable not only to a face plate including the partition members 19 constituted by strip-shaped portions separated from one another as illustrated in FIG. 2A, but also to a face plate including the partition members 19 constituted by grid shape member as illustrated in FIGS. 11A and 11B.

As the strip-shaped resistance members 21, resistive material such as ruthenium oxide, ITO, or the like can be used. The resistance between adjacent light emitting members can be in the range from 1 kΩ to 1 GΩ. Patterning of the strip-shaped resistance members 21 can be performed by an existing method such as printing or application using a dispenser.

The feeding electrode 22 may be made of any appropriate conductor such as a metal. In order to reduce voltage drop in the feeding electrode 22 when an acceleration voltage is supplied from a high-voltage terminal Hv described below, the resistance between a connection portion of the feeding electrode 22 to which the high-voltage terminal Hv is connected and a portion of the feeding electrode 22 that is farthest from the connection portion can be equal to or lower than 1 KΩ.

As the base 24, various materials can be used as long as the height of the base 24 can be controlled so that a step breakage may not occur at a connection portion between the feeding electrode 22 and the resistance members 21 on the partition members 19. For example, a material that emits only a small amount of gas in vacuum, such as polyimide, can be used. Alternatively, ceramics including alumina or zirconia, a fired paste including burned low-melting-point glass frit, or a composite of a metal oxide having a comparatively low conductivity, such as ZnO or SnO, and low-melting-point glass frit, can be used. A material the same as that of the partition members 19 can be used, and the base can be constituted by the partition members. The base 24 is adjacent to the partition members 19 in the sense that the base 24 is disposed such that the resistance members 21, which are disposed on the partition members 19 and on the base 24, do not fall onto the front substrate 31. As long as this condition is satisfied, the base 24 may be separated by a small distance from the partition members 19. The base 24 can be in contact with the partition members 19.

As illustrated in FIGS. 3 and 4, the present embodiment may include light-shielding members 18 disposed between the partition members 19 and the face plate 11.

The light-shielding members 18 may be a known black-matrix structure used for CRT and the like, which is typically made of a black metal, a black metal oxide, carbon, or the like. Examples of the black metal oxide include ruthenium oxide, chromium oxide, iron oxide, nickel oxide, molybdenum oxide, cobalt oxide, and copper oxide.

Next, the rear plate 12 is described. As illustrated in FIGS. 1 and 2B, the electron emitting devices 16 for exciting the light emitting members 17 to emit light are disposed on an inner surface of the rear plate 12. As the electron emitting devices 16, for example, surface-conduction electron emitting devices can be used. On the inner surface of the rear plate 12, the scanning wiring lines 14 and the information wiring lines 15 for supplying a driving voltage to the electron emitting devices 16 are disposed.

A spacer 13 can be disposed between the rear plate 12 and the face plate 11. The spacer 13 is a protective structure that protects against atmospheric pressure. The spacer 13 is disposed between adjacent light emitting members 17 so that the spacer 13 may not affect an image displayed by the image display apparatus.

The spacer 13 is made of an insulator, such as glass, or a composite of an insulator and a conductor. Alternatively, a surface of the spacer 13 may be covered with the resistance members. If the spacer 13 has a slight conductivity (hereinafter referred to as a conductive spacer), a benefit may be obtained in that the spacer is prevented from being charged. As a result, the path of electrons emitted from the electron emitting devices becomes stable, whereby an excellent image can be displayed.

The face plate 11, the rear plate 12, and the spacer 13, which are described above, are prepared. The spacer 13 is disposed between the face plate 11 and the rear plate 12. The image display apparatus 100 is formed by joining the peripheral edge portions of the face plate 11 and the rear plate 12 to each other with a side wall 26 therebetween.

In order to make the image display apparatus 100 display an image, a voltage is applied to the anode electrodes 20 from the power supply 27 through the feeding electrode 22 and the strip-shaped resistance members 21. At the same time, a driving voltage is applied to the electron emitting devices 16 from terminals Dy and Dx through the scanning wiring lines 14 and the information wiring lines 15, thereby making electron emitting devices 16 emit electron beams. The electron beams emitted from the electron emitting devices are accelerated and collide with the light emitting members 17. Thus, the light emitting members 17 are selectively excited so as to emit light, whereby an image is displayed.

### EXAMPLES

### First Example

A first example of the present invention is described below. Since the overall structure of the rear plate and the image display apparatus is described above, only the characteristics of the first example are described. FIG. 2A illustrates the face plate 11 of the first example viewed from the rear plate. FIGS. 3, 4 and 5 are sectional views taken along lines III-III, IV-IV, and V-V in FIG. 2A (or FIG. 1), respectively.

(Step 1: Forming Black-matrix) On a glass substrate that had been rinsed (PD200: on the front substrate 31), a black paste was printed, the paste was exposed and developed using photolithography and patterned in a matrix shape, so that the light-shielding members 18 serving as a so-called black-matrix were formed. The pitches of openings were 630 μm in the Y direction and 210 μm in the X direction, which were the same as the pitches of the electron-emitting devices that face the openings. The dimensions of the openings were 295 μm in the Y direction and 145 μm in the X direction.

(Step 2: Application of Materials of Partition Members and Base) In order to form partition members extending in the Y direction on the light-shielding members 18, a bismuth-oxide-base insulating paste was applied to the light-shielding members 18 using a slit coater such that the paste had a layer thickness of 190 μm after being fired, and the paste was dried for ten minutes at 120° C., so that preforms of the partition members were formed. To a periphery of the front substrate 31 on which the feeding electrode 22 was to be formed in subsequent steps, a zinc-oxide-base insulating paste was applied so as to be adjacent to the preforms of the partition members using a slit coater such that the paste had a layer thickness of 190 μm after being fired, and the paste was dried for ten minutes at 120° C., so that a preform of the base was formed.

(Step 3: Forming Partition Members and Base) A dry film resist (DFR) was laminated on the preforms of the partition members and on the preform of the base using a laminator. A chromium mask used for exposing the DFR was aligned in a predetermined position and the DFR was exposed so as to form a pattern. A portion of the chromium mask that has aperture of the preforms of the partition members had a shape such that the portion opened (so as to expose) strip-shaped areas extending in the Y direction, each having a width of 50 μm in the X direction, the strip-shaped areas overlapping the light-shielding members 18. A portion of the chromium mask that has aperture of the preform of the base had a shape such that the chromium mask opened a strip-shaped area extending in the X direction, the strip-shaped area having a width of 2 mm in the Y direction. The DFR was exposed using the chromium mask. The DFR was developed using developer (so that unexposed portions were removed), rinsed, and dried, so that a mask for sandblasting, which is made of the DFR having openings in desired positions, was formed. By performing sandblasting using abrasives such as stainless steel particles, unnecessary portions corresponding to the openings of the DFR were removed from the preforms of the partition members and from the preform of the base, so that the preforms of the partition members were patterned in strip shapes extending in the Y direction and the preform of the base was patterned in a strip shape extending in the X direction. Subsequently, the DFR was stripped using a resist stripper, and the substrate was cleaned.

(Step 4: Forming Resistance Members) On the preforms of the partition members having been thus patterned and on the preform of the base, a high resistance paste including ruthenium oxide was applied using a dispenser such that the paste had a layer thickness of 5 μm after being fired, and the paste was dried for ten minutes at 120° C. The volume resistivity of the high resistance paste, which was measured by applying the paste to a test pattern, was 10⁻¹ Ω·m.

(Step 5: Firing) The preforms of the partition members and the preform of the base were fired at 530° C., so that the partition members 19 constituted by strip-shaped members extending in the Y direction, the strip-shaped resistance members 21 disposed on the partition members and on the base 24, and the base 24 having a strip-shape extending in the X direction were formed.

(Step 6: Application of Phosphor) A paste dispersed with P22 phosphor used for CRT was used for the light emitting members 17. Using the paste, the phosphor was printed by a screen printing method to be aligned with the partition members 19 having strip-shaped openings. In the present example, phosphors for red, green, blue were applied in strip shapes so as to make a color display. The phosphors had a layer thickness of 15 μm. Subsequently, the phosphors for the three colors were dried at 120° C. The phosphors may be dried color by color or simultaneously for the three colors. Moreover, alkaline silicate, which is an aqueous solution including so-called water glass and serves as a binder, was sprayed on the phosphors.

(Step 7: Forming Metal Back) Acrylic emulsion was applied by spray coating and dried so as to fill spaces among phosphor powders with acrylic resin, and an aluminum layer to become the anode electrodes 20 was deposited on the phosphors. At this time, the anode electrodes 20 were formed using a metal mask having openings only in portions corresponding to the phosphors, which were the light emitting members 17, and portions corresponding to the strip-shaped resistance members 21. The thickness of the aluminum layer to become the anode electrodes 20 was 90 nm.

The material of the anode electrodes 20 is not limited to aluminum, and may be titanium, or chromium.

(Step 8: Forming Feeding Electrode) Next, the feeding electrode 22 was formed on the base 24 in such a manner that a portion of the feeding electrode 22 overlapped the resistance members 21. To be specific, using a printing screen having openings corresponding to a pattern of the feeding electrode 22, a glass paste in which silver particles were dispersed was printed on the base 24. At the same time, the connection portion 23 to be connected to the high-voltage pin 28 of the power supply 27 was formed on the base 24. The feeding electrode 22 and the connection portion 23 were dried at 120° C., and subsequently fired at 500° C.

(Step 9: Making Rear Plate and Spacer) The rear plate 12 was made by forming, on a glass material (PD200: the back substrate 32), the surface-conduction electron-emitting devices 16, the scanning wiring lines 14, and the information wiring lines 15, which are described above regarding the embodiment. In an area of the back substrate 32 that faces the connection portion 23 of the face plate 11, a hole was formed so that the high-voltage pin 28 could extend therethrough. The power supply 27 was disposed near an opening of the hole in a back surface of the back substrate 32 (a surface that does not face the face plate 11). The spacer 13 was made of glass (PD200).

Using the face plate 11, the rear plate 12, and the spacer 13 described above, the image display apparatus 100 illustrated in FIG. 1 was manufactured. When manufacturing the image display apparatus 100, alignment was carefully performed so that the high-voltage pin 28 of the power supply 27 contacted the connection portion 23 of the feeding electrode 22 disposed on the base. FIGS. 3, 4, and 5 are sectional views taken along lines III-III, IV-IV, and V-V in FIG. 1.

After the image display apparatus 100 had been made, a voltage of 8 kV was applied from the power supply 27 to the anode electrodes 20 through the feeding electrode 22 and the strip-shaped resistance members 21 so as to display an image. An excellent image having sufficient brightness without color mixture due to halation was displayed, because, as illustrated in FIGS. 3, 4, and 5, the image display apparatus 100 included the partition members 19 and the strip-shaped resistance members 21 disposed on the partition members 19. Stepped breakages did not occur in contact portions between the strip-shaped resistance members 21 and the feeding electrode 22, and a malfunction did not occur during a long-time display.

In the present embodiment, the strip-shaped resistance members 21 were formed on the partition members 19 and on the base 24. However, the present invention is not limited thereto. The feeding electrode 22 may be formed on the base 24 and on the partition members 19 so that the feeding electrode 22 is in contact with the resistance members 21 on the partition members 19.

### Second Example

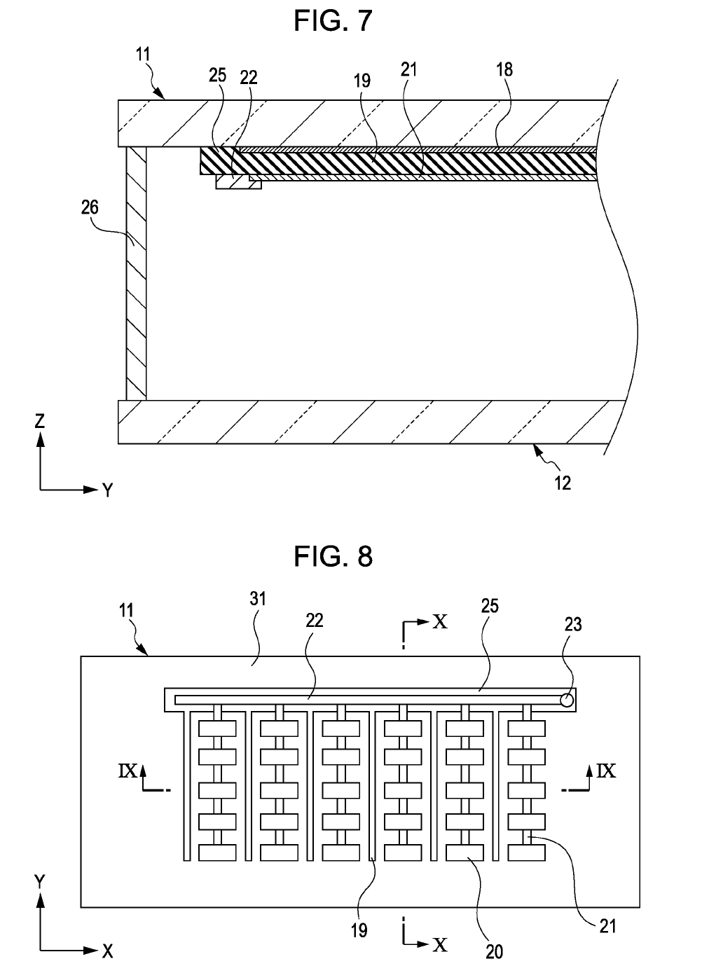

Next, a second example of the present invention is described. The basic structure of the second example is the same as that of the first example. The second example differs from the first example in that a face plate illustrated in FIGS. 6 and 7 was used in the second example. To be specific, the second example differs from the first example in that, as illustrated as a base 25, the partition members 19 were formed so as to extend to positions of the base 24 in the first embodiment, the feeding electrode 22 was disposed on the partition members 19, and the resistance members 21 were in contact with the high-voltage pin 28 of the power supply 27 on the partition members 19. FIG. 6 is a plan view of the face plate 11 viewed from the rear plate 12. FIG. 7 is a sectional view taken along line VII-VII in FIG. 6. A sectional view taken along line III-III in FIG. 6 is similar to FIG. 3.

Benefits similar to those of the first example were obtained with the second example. Since the partition members 19 include the base, the process of manufacturing the face plate was simplified. Moreover, the partition members 19 and the base 25 had a uniform height, gaps between the partition members 19 and the base 25 were eliminated, so that occurrence of a step breakage between the resistance members 21 and the feeding electrode 22 was securely prevented. As a result, the image display apparatus of the second example could operate more stably than that of the first example.

### Third Example

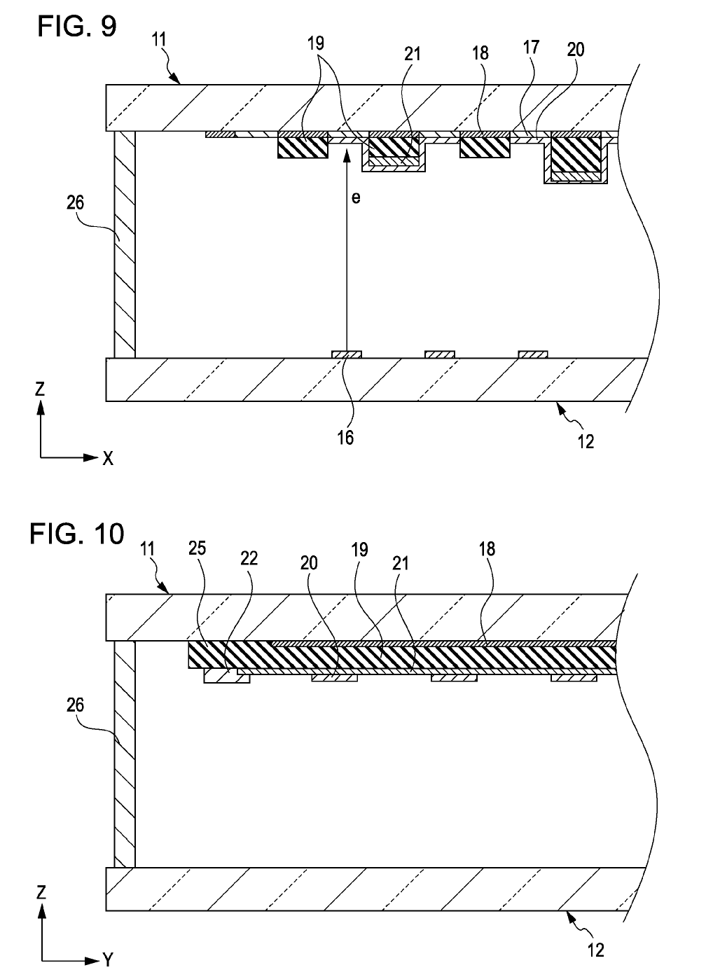

Next, a third example of the present invention is described. The basic structure of the third example is the same as that of the first example. The third example differs from the first example in that a face plate illustrated in FIGS. 8, 9, 10 was used in the third example. To be specific, the third example differs from the first example in that, as illustrated as the base 25, the partition members 19 were formed so as to extend to the position of the base 24 in the first embodiment, the feeding electrode 22 was disposed on the partition members 19, and the resistance members 21 were in contact with the high-voltage pin 28 of the power supply 27 on the partition members 19. Moreover, the third example differs from the first example in that the anode electrodes 20 covered two light emitting members adjacent to each other in the X direction, and the anode electrodes 20 covered the resistance members 21. FIG. 9 is a sectional view taken along line IX-IX in FIG. 8. FIG. 10 is a sectional view taken along line X-X in FIG. 8.

A voltage of 8 kV was applied from the power supply 27 to the anode electrodes 20 through the feeding electrode 22 and the strip-shaped resistance members 21 so as to make the image display apparatus 100 of the embodiment display an image. An excellent image having sufficient brightness without color mixture due to halation was displayed as in the case of the first embodiment. Stepped breakages did not occur in contact portions between the strip-shaped resistance members 21 and the feeding electrode 22, and a malfunction did not occur during a long-time display. Moreover, since the connection portions between the strip-shaped resistance members 21 and the anode electrodes 20 were covered with the anode electrodes 20, the anode electrodes 20 were electrically connected to the strip-shaped resistance members 21 more securely, so that the voltage of the anode electrodes became stable and a more excellent image was displayed.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-324471 filed Dec. 19, 2008, which is hereby incorporated by reference herein in its entirety.

What is claimed is:

1. An apparatus comprising:
a substrate;
light emitting members disposed on the substrate;
anode electrodes disposed on the light emitting members in an overlapping manner;
a partition member disposed between adjacent light emitting members, the partition member protruding from a surface of the substrate;
a resistance member disposed on the partition member, the resistance member connecting adjacent anode electrodes to each other; and
a feeding electrode connecting the resistance member to a power supply,
wherein the feeding electrode is disposed on one of the partition member and a base adjacent to the partition member, the feeding electrode is in contact, on one of the partition member and the base, with the resistance member, and the feeding electrode includes a connection portion at which the feeding electrode is connected to the power supply, the connection portion being disposed on one of the partition member and the base.

2. The apparatus according to claim 1, wherein the resistance member is a strip-shape resistance member.

3. An apparatus comprising:
a rear plate including electron emitting devices; and
a fluorescent screen including
a substrate,
light emitting members disposed on the substrate,
anode electrodes disposed on the light emitting members in an overlapping manner,
a partition member disposed between adjacent light emitting members, the partition member protruding from a surface of the substrate,
a resistance member disposed on the partition member, the resistance member connecting adjacent anode electrodes to each other, and
a feeding electrode connecting the resistance member to a power supply,
wherein the feeding electrode is disposed on one of the partition member and a base adjacent to the partition member, and the feeding electrode is in contact, on one of the base and the partition member, with the resistance member and with a terminal connected to the power supply.

4. The apparatus according to claim 3, wherein the resistance member is a strip-shape resistance member.

5. A method comprising:
disposing light emitting members on a substrate;
disposing anode electrodes on the light emitting members in an overlapping manner;
disposing a partition member between adjacent light emitting members, the partition member protruding from a surface of the substrate;
disposing a resistance member on the partition member, the resistance member connecting adjacent anode electrodes to each other; and
connecting the resistance member to a power supply by a feeding electrode,
wherein the feeding electrode is disposed on one of the partition member and a base adjacent to the partition member, the feeding electrode is in contact with the resistance member, and the feeding electrode includes a connection portion at which the feeding electrode is connected to the power supply, the connection portion being disposed on one of the partition member and the base.

6. The method according to claim 5, wherein when the feeding electrode is disposed on the base, the feeding electrode is in contact, on the base, with the resistance member.

7. The method according to claim 5, wherein the resistance member is a strip-shape resistance member.

8. A method comprising:
providing a rear plate including electron emitting devices; and
providing a fluorescent screen including
disposing light emitting members on a substrate,
disposing anode electrodes on the light emitting members in an overlapping manner,
disposing a partition member between adjacent light emitting members, the partition member protruding from a surface of the substrate,
disposing a resistance member on the partition member, the resistance member connecting adjacent anode electrodes to each other, and
connecting the resistance member to a power supply by a feeding electrode,
wherein the feeding electrode is disposed on one of the partition member and a base adjacent to the partition member, and the feeding electrode is in contact, on one of the base and the partition member, with the resistance member and with a terminal connected to the power supply.
